(19) United States
(12) Patent Application Publication
(10) Pub. No.: US 2009/0277319 A1
(43) Pub. Date: Nov. 12, 2009

(54) SOUND POST SETTER

(76) Inventor: George Beter, Huntington, WV (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 12/116,035

(22) Filed: May 6, 2008

(51) Int. Cl. G10D 1/02

(52) U.S. Cl. 84/277

(57) ABSTRACT

A device for installing a sound post in a musical instrument comprises a handle and an arm depending from the handle, the handle and arm defining a passageway therein. The device includes a cradle depending from the arm, the cradle having an opening formed at the junction of the cradle and the arm. The device also includes a cable having a nib at an end, the cable traversing the passageway. The device also includes a lever or knob moving the cable to advance or retract the nib through the opening.

### FIELD OF INVENTION

This application discloses claims and embodiments generally related to a device for installing a sound post in a musical instrument, and more particularly, a device having a retracting nib or spike for temporarily holding the sound post during installation.

### BACKGROUND OF THE INVENTION

A number of stringed-instruments fabricated from wood possess a solid cylindrical element referred to as a sound post, including violins, violas and cellos. Generally, the sound post is a solid cylinder of wood (e.g. spruce) and is used to support the belly of such an instrument. The sound post is impinged between the top and the rear of the wood instrument and within the belly of the instrument. The sound post is not glued, adhered or mechanically affixed between the front and rear, but is held in position by the tension of the front and rear portions of the instrument, generally as a result of the pull of the strings on the instrument, and by the generally complementary angles placed on the ends of the sound post. The sound post reinforces the treble-side of the instrument and influences the vibration characteristics of the instrument, thereby influencing the sound generated by the instrument. As a consequence, placement of the sound post is critical to the tonal quality of the instrument, and may be altered by placing the sound post in a different position.

The permanent uni-body construction of wood instruments, like the violin, viola and cello, and the delicate nature and care that must be exercised in maintenance and repair of such instruments, requires a delicate tool and skillful dexterity for installing and/or replacing a sound post. Installation or replacement of a sound post is performed through the “f-hole” formed in the top surface of the instrument—the outlet through which the generated sound is transmitted. On smaller instruments, like the viola and violin, each “f-hole” has a correspondingly small width and length and an unusual shape. These physical characteristics present obstacles to a musician or repair-person wanting to install or replace a sound post. Generally, the sound post is diagonally passed through a narrow “f-hole” and into the belly of the instrument, turned vertically and wedged into place between the top and rear surfaces. Then, the sound post must be rotated so that the angle of sound post meets the angles of the top and the back surfaces.

As a consequence of the design and size of the instrument(s), there have been many attempts to provide a tool (or tools) that permit a user to install or replace a sound post without damaging the instrument, including the “f-hole”, while reducing the time and frustration that may be associated with the maintenance. The art includes many such attempts and improvements. For example, a wrench-type tool has been utilized that usually requires the sound post to be placed in a cradle or loop, such as those described in U.S. Pat. No. 5,804,748 (Clayton), U.S. Pat. No. 2,522,190 (Mouser) and U.S. Pat. No. 1,556,340 (Myers). Even pliers have been proposed, such as in U.S. Pat. No. 1,466,681 (Todd). Although these devices permit installation through the “f-hole”, they fail to provide the control necessary to tightly wedge and/or turn the sound post so that it meets the angles of the top and the rear surfaces.

The art does not appear to disclose the combination of elements and features disclosed herein, including the novel combination of elements and/or materials disclosed hereinafter. In particular, the disclosure provided herein provides considerable improvement over the known art, especially in providing the user with better control and dexterity over the device, and thus the placement of the sound post. Thus, it is advantageous to have an apparatus or device having the elements and features disclosed herein.

This application presents claims and embodiments that fulfill a need or needs not yet satisfied by the products and inventions previously or presently available, or proposals previously disclose, including the example of the art presented above. In particular, the claims and embodiments disclosed herein describe a device for installing a sound post in a musical instrument with a single hand, the device generally comprising a handle, an arm, a cradle at the end of the arm, and a cable having a nib, whereby the nib impales the sound post. The user may then insert the device, with the impaled sound post, into the belly of the instrument, and place it accordingly. Upon proper alignment, the nib is released, thereby retracting from the sound post, freeing the device to be removed from the instrument. As shall be disclosed, the embodiments and claims described herein provide an unanticipated and nonobvious combination of features distinguished from the products and inventions preexisting in the art. The applicant is unaware of any product, disclosure or reference that discloses the features of the claims and embodiments disclosed herein, and as more fully described below.

### SUMMARY OF THE INVENTION

In accordance with one embodiment, a device for installing a sound post in a musical instrument is described, the device comprising: a handle and an arm depending from the handle, the handle and arm defining a passageway therein; a cradle depending from the arm, the cradle having an opening formed at the junction of the cradle and the arm; a cable having a nib at an end, the cable traversing the passageway; and means for selectively moving the cable to advance or retract the nib through the opening.

In accordance with another embodiment, a device for installing a sound post in a musical instrument is described, the device comprising: a handle; an arm depending from the handle, the arm angularly disposed to offset a distal end of the arm from the longitudinal axis of the handle; a cradle depending from the arm, the cradle angularly disposed from the arm; the handle and arm defining a passageway therein terminating at an opening formed in the cradle; a cable having a nib at an end, the cable traversing the passageway; and means for selectively moving the cable to retract the nib into the opening, the moving means positioned on the handle.

In accordance with another embodiment, a device for installing a sound post in a musical instrument is described, the device comprising: a handle having a channel; an arm depending from the handle, the arm angularly disposed to offset a distal end of the arm from the longitudinal axis of the handle; a cradle depending from the arm, the cradle angularly disposed incidental to the arm; the handle and arm defining a passageway therein terminating at an opening formed in the cradle; a cable having a nib at an end, the cable traversing the passageway; and means for selectively moving the cable to retract the nib into the opening, the moving means positioned on the handle and traversing the channel; the moving means comprising a lever and a carrier, and further comprising a support disposed between the lever and the carrier.

In each of the embodiments described above, and for other embodiments not specifically described but contemplated and/or within the scope of the descriptions herein, the cradle may comprise a semi-cylindrical form receiving the sound post. The cradle may also comprise a semi-cylindrical form having a space defined by the margins of the semi-cylindrical form. The cradle may have an angular disposition incident to the arm, the angular disposition generally spanning a range of 30 degrees to 60 degrees incident to the arm.

In each of the embodiments described above, and for other embodiments not specifically described but contemplated and/or within the scope of the descriptions herein, the moving means is coupled with an outwardly biased spring for placing the cable and nib in an advanced default position. Conversely, the moving means may be coupled with an inwardly biased spring for placing the cable and nib in a retracted default position.

In each of the embodiments described above, and for other embodiments not specifically described but contemplated and/or within the scope of the descriptions herein, the handle may further comprise a channel housing the moving means. The handle may also further comprise an outwardly biased spring coupled to the moving means.

In each of the embodiments described above, and for other embodiments not specifically described but contemplated and/or within the scope of the descriptions herein, the moving means may comprise a lever and a carrier, a support disposed between the lever and the carrier, and the carrier coupled to the outwardly biased spring at one end and coupled to the cable at the opposing end. The outwardly biased spring urges the moving means, the cable and the nib to an advanced default position, wherein the nib is advanced through the opening and within the interior of the cradle.

In each of the embodiments described above, and for other embodiments not specifically described but contemplated and/or within the scope of the descriptions herein, the arm may be curvilinear from the proximal end to the distal end. Conversely, the arm may be linear from the proximal end to the distal end.

In each of the embodiments described above, and for other embodiments not specifically described but contemplated and/or within the scope of the descriptions herein, the cable comprises a flexible material.

In each of the embodiments described above, and for other embodiments not specifically described but contemplated and/or within the scope of the descriptions herein, the nib impales the sound post.

### BRIEF DESCRIPTION OF THE DRAWINGS

FIG. 1 is a side view of a device for setting a sound post for a musical instrument;

FIG. 2 is an enlarged view of a cradle receiving a sound post, a nib of the device impaling the sound post;

FIG. 3 is a top view of a device for setting a sound post for a musical device as depicted in FIG. 1;

FIG. 4 is an end view of a device for setting a sound post for a musical instrument;

FIG. 5 is a side view of a device for setting a sound post for a musical instrument similar to that depicted in FIG. 1, further depicting components of a handle, an arm, a cable having a nib, and means for moving the cable and the nib;

FIG. 6 is an enlarged view of a cradle receiving a sound post, a nib of the device impaling the sound post, further depicting the cable and nib in detail;

FIG. 7 is a top view of a device for setting a sound post for a musical device as similarly depicted in FIG. 3, further depicting the components as revealed in FIG. 5; and

FIG. 8 is an end view similar to that of FIG. 4, further depicting the components as reveal in FIG. 5 though FIG. 7.

### DESCRIPTION OF THE EMBODIMENTS

Generally, the sound post referenced herein shall be denoted as “P” unless otherwise indicated. It is intended, and envisioned, that a sound post is configured in keeping with the current understanding in the art, having a generally solid cylindrical shape and normally formed of a wood product (e.g. spruce) utilized in wooden stringed-instruments, such as a viola, violin or cello (though not necessarily exhaustive). Although the axial length of the sound post “P” may vary in accordance with the specific instrument, usually the smallest sound post “P” measures approximately six centimeters, with longer lengths available for larger instruments. The terminal ends of the sound post “P” may be planar or angular, or may be tailored to be complementary to the inner surfaces of the top surface and rear surface, respectively, of the wood instrument. The specific placement of the sound post “P” conforms to the accepted practices, including placement along the treble side of the instrument, although variation of placement along the treble side are envisioned for altering the tonal quality as desired.

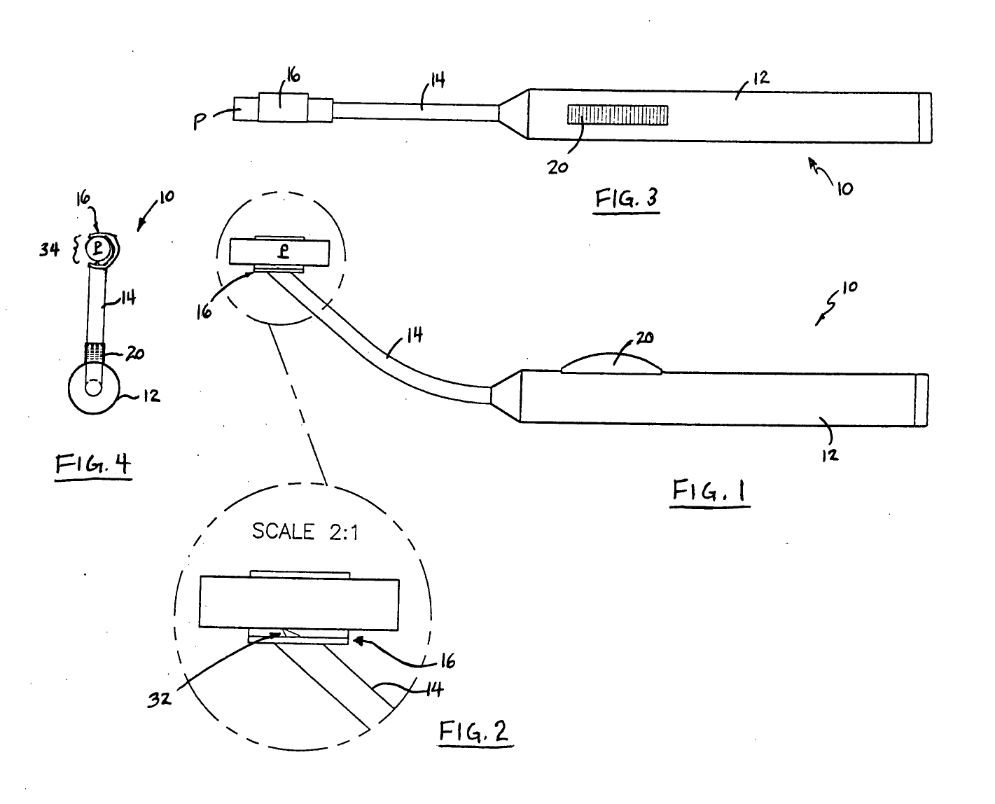

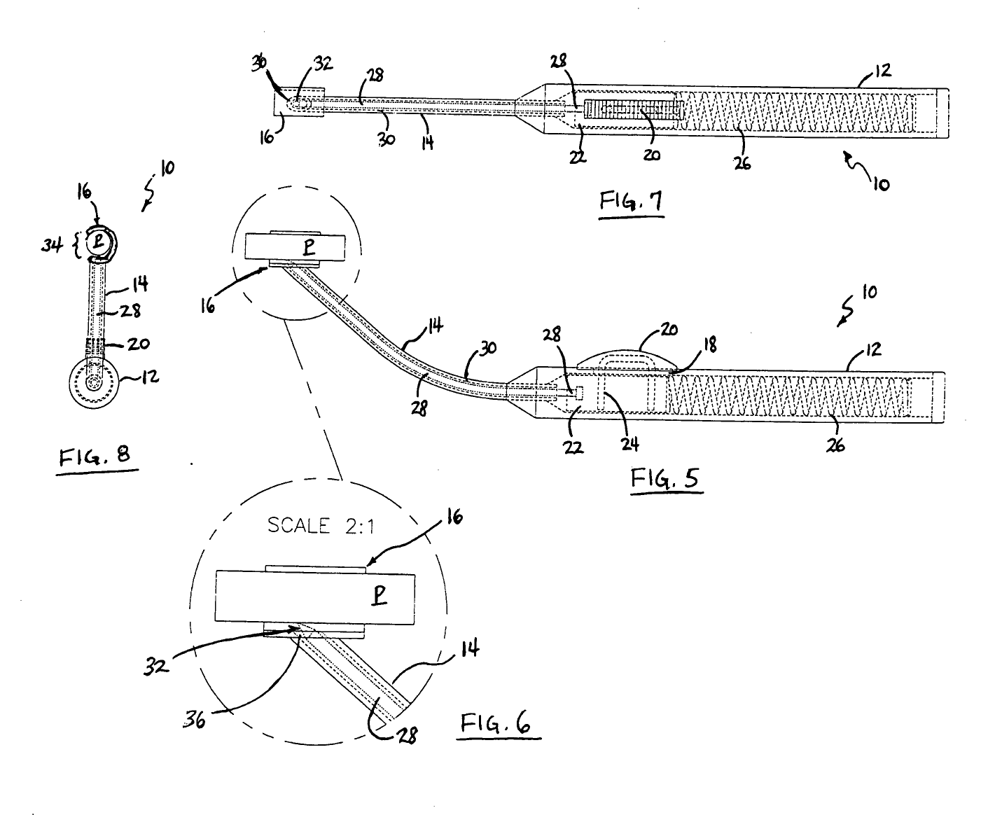

With reference to the figures, specifically FIG. 1 through FIG. 8, a device for installing a sound post in a musical instrument 10 (hereinafter “device”) is disclosed, the device 10 comprising a handle 12, an arm 14 and a cradle 16. The handle 12 is elongated for comfortable grasping by a user. The arm 14 depends from and is mutually coupled with the handle 12. As depicted in FIG. 1, the arm 14 is angularly disposed from the handle 12 so that cradle-end of the arm 14 is offset from the longitudinal axis (not depicted) of the handle 12. The handle 12 is grasped by the user, while the arm 14 and cradle 16 are utilized for receiving and temporarily securing the sound post “P” until placement has been accomplished.

In one embodiment of the device 10, the handle 12 comprises a channel 18 for accommodating a slidable or movable lever or knob 20 mounted on or coupled therethrough. As but one example, the lever or knob 20 is coupled to a carrier 22 via a support 24 disposed between the lever 20 and the carrier 22. The carrier 22 is coupled to an outwardly biased spring 26 at one end and coupled to a cable 28 at the opposing end. It is envisioned that other similar levers or knobs may be coupled with substitute elements to achieve the same or similar functions. It is also envisioned that the lever or knob 20 may be formed into a variety of shapes or forms, including the generally arcuate shape depicted in the figures. It is also envisioned that the lever or knob 20 may comprise a manually engageable surface thereon to enhance engagement of a user's finger to the lever or knob 20.

The cable 28 traverses a passageway 30 formed within or defined by the internal dimensions and configurations of the handle 12 and arm 14, respectively. In other words, the handle 12 and arm 14 form an interior pathway 30 that encloses the cable 28. The cable 28 may be fabricated from a variety of materials, including metal wire, plastic or other suitable material(s). It is envisioned that the cable 28 is flexible, yet rigid and durable. The cable 28 must maintain structural integrity to respond to movement of the lever or knob 20. The cable 28 must also maintain structural integrity to respond to the bias of the spring 26, in particular in the outwardly biased spring 26 that urges the cable 28 (and attached nib 32) into an advanced position and engaging the sound post “P” held in the cradle 16. The cable 28 has an attached end that is coupled to the carrier 22, and a free end that includes a nib 32. The nib 32 is a sharpened or pointed element that is impaled into the sound post “P”, as will be described below.

The arm 14 is angularly disposed in relation to the handle 12. In one embodiment, the angular disposition and offset is achieved via an arm 14 that is curvilinear from the proximal end (attached at the handle 12) to the distal end terminating with the cradle 16. In another embodiment, the angular disposition and offset is achieved via an arm 14 that is linear from the proximal end to the distal end. The pathway 30 within the arm 14 follows the form of the arm 14, and is generally free of any obstructions that would inhibit the free reciprocating movement of the cable 28 traversing therethrough. The pathway 30 terminates at an opening 36 formed in the cradle 16, the nib 32 projecting therefrom in an advanced position. The arm 14 may be fabricated from a variety of materials, including any durable materials such as metal, plastic or other suitable materials. In another embodiment, it is envisioned that the arm 14 may be fabricated from a flexible material that permits the user to manually adjust the angle of the arm 14 relative to the handle 12 to negotiate difficult installations. It is envisioned that the length of the arm 14 may encompass a range of between two (2) inches and four (4) inches to accommodate instruments of various sizes and dimensions. It is also envisioned that the handle 12 may be fabricated from a variety of materials, including metal, plastic or other suitable materials, and may be formed into a variety of shapes, including the generally cylindrical shape depicted in the figures. It is also envisioned that the handle 12 may be fabricated to include an integral or an attached ergonomic grip. It is also envisioned that a supportive skirt or collar may be disposed between the handle 12 and arm 14, the skirt or collar providing additional support to the angular disposition of the arm 14 and preventing structural compromise of the device 10.

The cradle 16 has a substantially semi-cylindrical form, wherein the terminal margins of the semi-cylindrical cradle 16 defines a space 34. The space 34 permits ingress and egress of the sound post “P”. Once the sound post “P” is finally positioned, the device 10 may be extracted from the belly of the instrument by releasing the sound post “P” from the nib 32, and then releasing the sound post “P” completely from the cradle 16 through the space 34. Alternatively, and under certain conditions, it may be necessary to release the sound post “P” from the cradle 16 through one of the ends of the cradle 16. The cradle 16 is angularly disposed incident to the arm 14, and may generally comprise the range of 30 degrees to 60 degrees incident to the arm 14. Because the cradle 16 is generally aligned so that its longitudinal axis is parallel to the longitudinal axis of the handle 12, the angle may be measured using the cradle 16 as the reference. It is envisioned that separate embodiments encompassing specific angular dispositions are desirable, such as an embodiment wherein the angle between the cradle 16 and the arm 14 is approximately 30 degrees. Another similar embodiment would include an angle of approximately 40 degrees. Another similar embodiment would include an angle of approximately 50 degrees. Another similar embodiment would include an angle of approximately 60 degrees. The cradle 16 may have an axial length within a range of approximately two centimeters up to approximately five centimeters. This range accommodates the smallest sound post “P” utilized, and prevents the cradle 16 from interfering with the positioning of the sound post “P” within the belly of the instrument.

In operation, and in accordance with the descriptions and variations that may be achieved from the descriptions above, the device 10 comprises a handle 12 having a lever 20 coupled to a carrier 22 via a support 24 disposed between the lever 20 and the carrier 22. The carrier 22 is coupled to an outwardly biased spring 26 at one end and coupled to a cable 28 at the opposing end. In this embodiment, the outward bias of spring 26 places the cable 26 and the attached nib 32 into an advanced default position, wherein the nib 32 is advanced and projecting out from the opening 36 formed in the cradle 16 and defining a terminal end of the arm 14 and passageway 30. The lever 20 is urged against the outwardly biased spring 26 to retract the cable 26 and nib 32 within the passageway 30, providing an unobstructed void for manual insertion of a sound post “P”. Thereafter, the sound post “P” positioned within the cradle 16 is impaled by the nib 32 in the advanced default position by releasing the lever 20 and permitting the outward bias of spring 26 to urge the cable 26 and nib 32 in the advanced position, thereby impaling nib 32 into the sound post “P”.

Once the lever 20 is released, and the sound post “P” impaled within the cradle 16 (by nib 32), the user can then freely grasp the device 10 without having to worry about maintaining the nib 32 in the advanced position. As a result, the user may hold the device 10 like a pencil, wherein the handle 12 would be positioned between the thumb and index finger of the user's hand. This grip is preferred, but not limited to, and provides greater maneuverability and dexterity in comparison to a handshake or handle-bar grip that is usually employed with tools of this type. Therefore, insertion of the device 10 through the “f-hole”, and manipulation within the belly of the instrument, are more easily achieved with the device 10 and the grip employed to use the device 10.

The sound post “P” must be set into position first along its bottom surface, and with the top surface angled away in the opposite direction, and then pulled back toward the user to set the top surface therein. The angular disposition/offset of the arm 14 relative to the handle 12 further permits the user to easily manipulate the device 10 in an up and down motion. This configuration helps protect the sides of the “f-holes” by minimizing incidental contact between the device 10 and the sides of the “f-holes” by providing sufficient clearance between the device 10 and the “f-hole”. By comparison, post-setting devices not possessing the angular offset of the arm 14 (e.g. straight-line device) cannot achieve the same result, lacking the clearance and the angle to both set and release sound post “P” without striking or contacting the “f-hole”. After the sound post “P” is set within the instrument, the sound post “P” is released by the user urging the lever 20 against the outward bias of spring 26, thereby retracting the cable 26 and nib 32 into the passageway 30 of arm 14.

Further consideration is given to circumstances in which a larger-than-normal sound post “P” is utilized. The post “P” may have a thickness too large to fit in the widest-part of the “f-hole”. Instead, the post “P” may be inserted through a lobe of the “f-hole”, apart from the device 10. Thereafter, the device 10 may be inserted through the “f-hole”. The device 10 may then be used to impale the nib 32 into the free and non-placed post “P” by urging the lever 20 to retract the nib 32 into the passageway 30. The device 10 can then be manipulated to position the cradle 16 about the post “P”, and then releasing the lever 20, the outwardly biased spring 26 urges the nib 32 back to the advanced default position, thereby impaling the nib 32 into the post “P”. From there, the user may manipulate the post “P” in accordance with the general descriptions provided above.

It is to be understood that the embodiments and claims are not limited in its application to the details of construction and arrangement of the components set forth in the description and illustrated in the drawings. Rather, the description and the drawings provide examples of the embodiments envisioned, but the claims are not limited to the specific embodiments. The embodiments and claims disclosed herein are further capable of other embodiments and of being practiced and carried out in various ways, including various combinations and sub-combinations that may not have been explicitly disclosed. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claimed appended hereto.

What is claimed is:

1. A device for installing a sound post in a musical instrument comprising:
a handle and an arm depending from the handle, the handle and arm defining a passageway therein;
a cradle depending from the arm, the cradle having an opening formed at the junction of the cradle and the arm;
a cable having a nib at an end, the cable traversing the passageway; and
means for selectively moving the cable to advance or retract the nib through the opening.

2. The device of claim 1, wherein the cradle comprises a semi-cylindrical form receiving the sound post.

3. The device of claim 1, wherein moving means is coupled with an outwardly biased spring for placing the cable and nib in an advanced default position.

4. The device of claim 1, wherein moving means is coupled with an inwardly biased spring for placing the cable and nib in a retracted default position.

5. A device for installing a sound post in a musical instrument comprising:
a handle;
an arm depending from the handle, the arm angularly disposed to offset a distal end of the arm from the longitudinal axis of the handle;
a cradle depending from the arm, the cradle angularly disposed from the arm;
the handle and arm defining a passageway therein terminating at an opening formed in the cradle;
a cable having a nib at an end, the cable traversing the passageway; and
means for selectively moving the cable to retract the nib into the opening, the moving means positioned on the handle.

6. The device of claim 5, wherein the handle further comprises a channel housing the moving means.

7. The device of claim 5, wherein the handle further comprises an outwardly biased spring coupled to the moving means.

8. The device of claim 7, wherein the outwardly biased spring urges the moving means, the cable and the nib to an advanced default position, wherein the nib is advanced through the opening and within the interior of the cradle.

9. The device of claim 5, wherein the moving means comprising:
a lever and a carrier;
a support disposed between the lever and the carrier; and
the carrier coupled to the outwardly biased spring at one end and coupled to the cable at the opposing end.

10. The device of claim 5, wherein the arm is curvilinear from the proximal end to the distal end.

11. The device of claim 5, wherein the cradle comprises a semi-cylindrical form having a space defined by the margins of the semi-cylindrical cradle.

12. The device of claim 5, wherein the cradle has an angular disposition approximately 40 degrees incident to the arm.

13. The device of claim 5, wherein the cradle has an angular disposition approximately 50 degrees incident to the arm.

14. The device of claim 5, wherein the cradle has an angular disposition approximately 60 degrees incident to the arm.

15. The device of claim 5, wherein the cable comprises a flexible material.

16. The device of claim 5, wherein the nib impales the sound post.

17. A device for installing a sound post in a musical instrument comprising:
a handle having a channel;
an arm depending from the handle, the arm angularly disposed to offset a distal end of the arm from the longitudinal axis of the handle;
a cradle depending from the arm, the cradle angularly disposed incidental to the arm;
the handle and arm defining a passageway therein terminating at an opening formed in the cradle;
a cable having a nib at an end, the cable traversing the passageway; and
means for selectively moving the cable to retract the nib into the opening, the moving means positioned on the handle and traversing the channel;
the moving means comprising a lever and a carrier, and further comprising a support disposed between the lever and the carrier.

18. The device of claim 18 further comprising the carrier coupled to the outwardly biased spring at one end thereof and coupled to the cable at the opposing end thereof.

19. The device of claim 18, wherein the arm is curvilinear from the proximal end to the distal end.

20. The device of claim 18, wherein the cradle has angular disposition of approximately 30 degrees to 60 degrees incident to the arm.
